(19) United States
(12) Patent Application Publication
(10) Pub. No.: US 2020/0262259 A1
(43) Pub. Date: Aug. 20, 2020

(54) 4-WHEEL INDEPENDENT SUSPENSION OFF-ROAD TOWABLE VEHICLE

(71) Applicant: Marion Buchanan Ford, Hampstead, MD (US)

(72) Inventor: Marion Buchanan Ford, Hampstead, MD (US)

(21) Appl. No.: 16/791,239

(22) Filed: Feb. 14, 2020

Related U.S. Application Data
(60) Provisional application No. 62/807,200, filed on Feb. 18, 2019.

(51) Int. Cl. B60G 7/00; B60D 1/167; B62D 7/16

(52) U.S. Cl. CPC B60G 7/008; B60D 1/167; B62D 7/16; B60G 2300/07; B60G 2204/148; B60G 2204/1244; B60G 2200/10

(57) ABSTRACT

A towable off-road vehicle is provided with four-wheel independent suspension and an articulating tow bar, wherein an occupant is afforded rollover protection that allows them to be safely towed off road, yet empowering the occupant to follow the towed off-road vehicle with an independent suspension and steering system facilitated by an articulating tow bar for driving in the towing vehicle's tracks, thereby allowing more people to experience the excitement of off-roading first-hand.

### CROSS-REFERENCE TO RELATED APPLICATION

This application claims the benefit of priority of U.S. provisional application No. 62/807,200, filed 18-Feb.-2019, the contents of which are herein incorporated by reference.

### BACKGROUND OF THE INVENTION

The present invention relates to off road vehicles and, more particularly, to a four-wheel independent suspension off-road towable vehicle with an articulating tow bar.

There are many off-road vehicle enthusiasts. There are arguable many more who would like to participate in off-road adventures but who find blazing trails as the driver of such vehicles in extreme off-road conditions too daunting and thus unsafe. Currently, the closest thing to off-road vehicles that one can sit in but not be completely responsible for navigating a trail is when the off-road vehicle is loaded on a traditional trailer for being transported to the desired off-roading location, but that is not what much of anyone would deem a satisfactory alternative. Moreover, even if one were fine with sitting in an un-powered off-road vehicle in the back of a traditional trailer, there are locations that would be ideal for off-roading, but inaccessible by the above-mentioned traditional trailer, and thus power-less off-road vehicles would not be transported to such locations absent the passenger-less off-road vehicle being towed by another off-road vehicle.

As can be seen, there is a need for a towable off-road vehicle that is adapted to enable passengers to be towed by another off-road vehicle in relatively safety and comfort through extreme off-road conditions, while still empowering the passenger of the towed off-road vehicle with a working suspension and steering system they can follow precisely in the towing vehicle's tracks, thereby allowing more people to experience the excitement of off-roading first-hand. Specifically, the present invention embodies a towable off-road vehicle with four-wheel independent suspension and an articulating tow bar.

### SUMMARY OF THE INVENTION

In one aspect of the present invention, an off-road vehicle includes the following: a multi-wheel independent suspension system; and an articulating tow bar.

In another aspect of the present invention, the off-road vehicle includes the following: a multi-wheel independent suspension system; an articulating tow bar; a base frame; a spindle for each wheel of the multi-wheel independent suspension system; two control arms operatively associating each spindle to the base frame by way of tie rod ends/heim joints; and a spring/shock absorber operatively associating one of each two control arms to the base frame; the articulating tow bar further includes the following: a distal draw bar section; a proximal draw bar section; an up-and-down pivot point interconnecting the distal draw bar section and the proximal draw bar section; the distal and proximal draw bar sections upwardly and downwardly movable relative to each other about the up-and-down pivot point; and one or more lateral pivot points one the proximal draw bar section for moving laterally relative the distal draw bar section; a left tie rod/steering rod and a right tie rod/steering rod; and; each tie rod/steering rod extending from the proximal draw bar section to a rod joint point on each spindle, wherein each spindle provides a circular flange, wherein the two tie rod ends/heim joints are diametrically opposed along a circumference of said circular flange, and wherein the rod joint point is along the circumference between the two suspension pivot points.

These and other features, aspects and advantages of the present invention will become better understood with reference to the following drawings, description and claims.

### BRIEF DESCRIPTION OF THE DRAWINGS

FIG. 1 is a bottom plan view of an exemplary embodiment of the present invention;

FIG. 2 is a side elevation view of an exemplary embodiment of the present invention, illustrating an exterior frame;

FIG. 3 is a schematic view of an exemplary embodiment of a wheel area of the present invention;

FIG. 4 is a schematic view of an exemplary embodiment of an underside of the present invention;

FIG. 5 is a side view of an exemplary embodiment of a spindle of the present invention, shown in use;

FIG. 6 is a detailed elevation view of an exemplary embodiment of the present invention;

FIG. 7 is a detailed view of an exemplary embodiment of a spindle 30 of the present invention;

FIG. 8 is a detailed view of an exemplary embodiment of the spindle 30, a control arm 14 and a spring/shock 32 of the present invention;

FIG. 9 is a top view of an exemplary embodiment of a tow/draw bar of the present invention; and

FIG. 10 is a side elevation view of an exemplary embodiment of the tow/draw bar of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a towable off-road vehicle with four-wheel independent suspension and an articulating tow bar, wherein the occupant is afforded rollover protection that allows them to be safely towed off road, yet empowering the occupant to ride the towed off-road vehicle with an independent suspension and steering system facilitated by the articulating tow bar to follow in the towing vehicle's tracks, thereby allowing more people to experience the excitement of off-roading first-hand.

It should be understood by those skilled in the art that the use of directional terms such as upper, lower, upward, downward, top, bottom, left, right and the like are used in relation to the illustrative embodiments as they are depicted in the figures, the upward direction (or upper) being toward the top of the corresponding figures, and the downward direction (or lower) being toward the bottom of the corresponding figures.

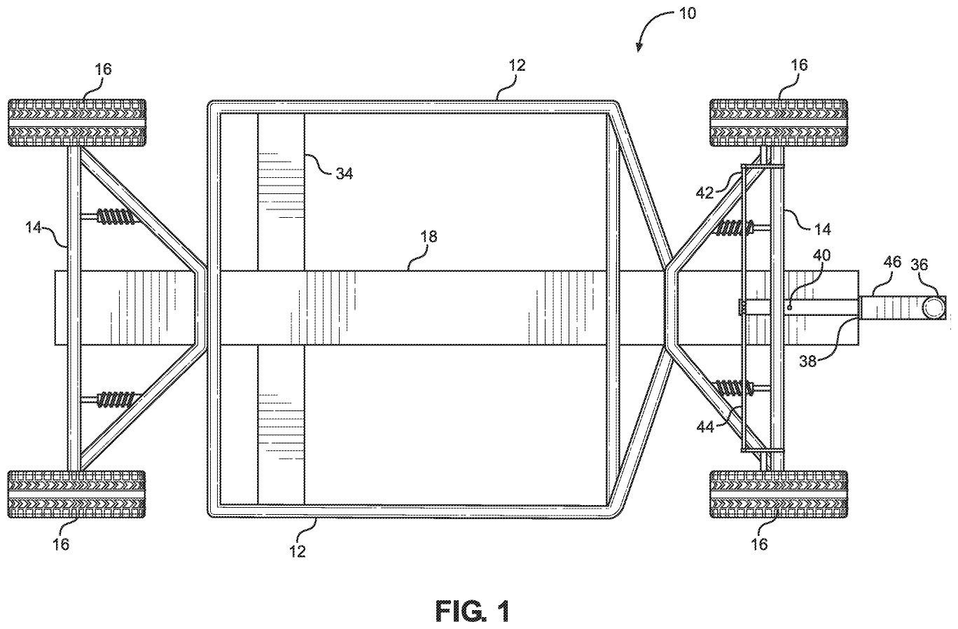

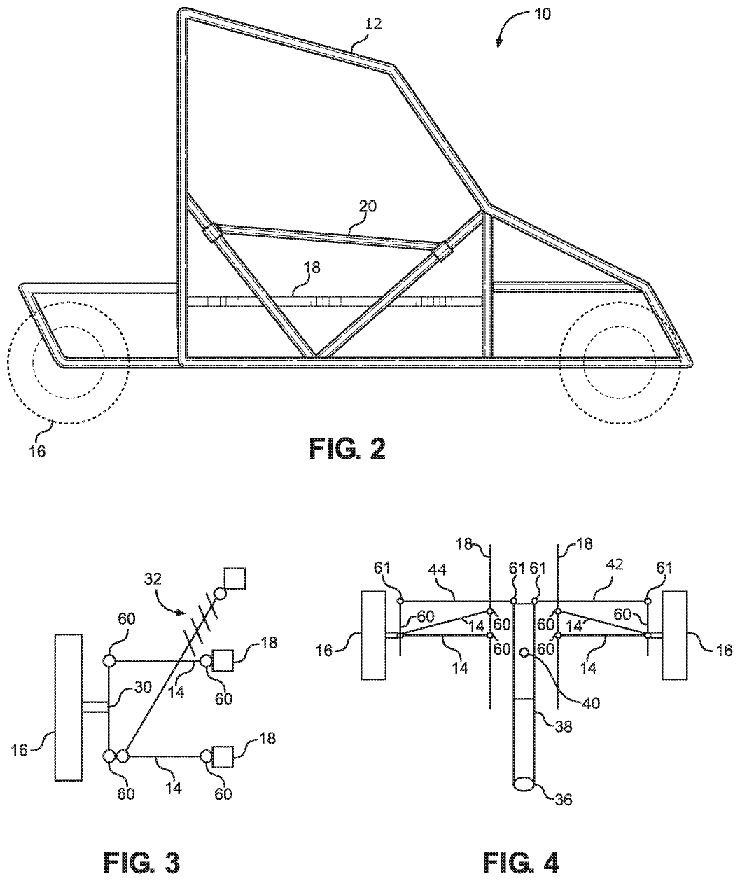

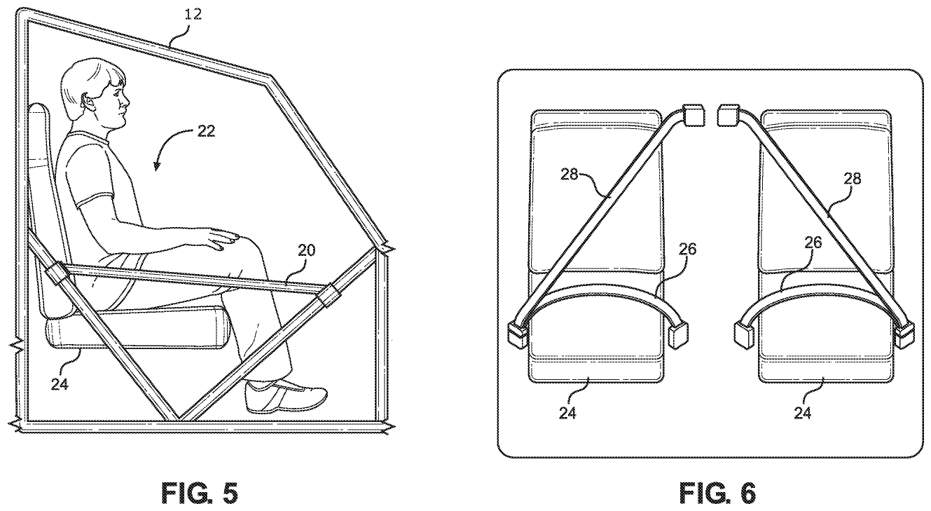

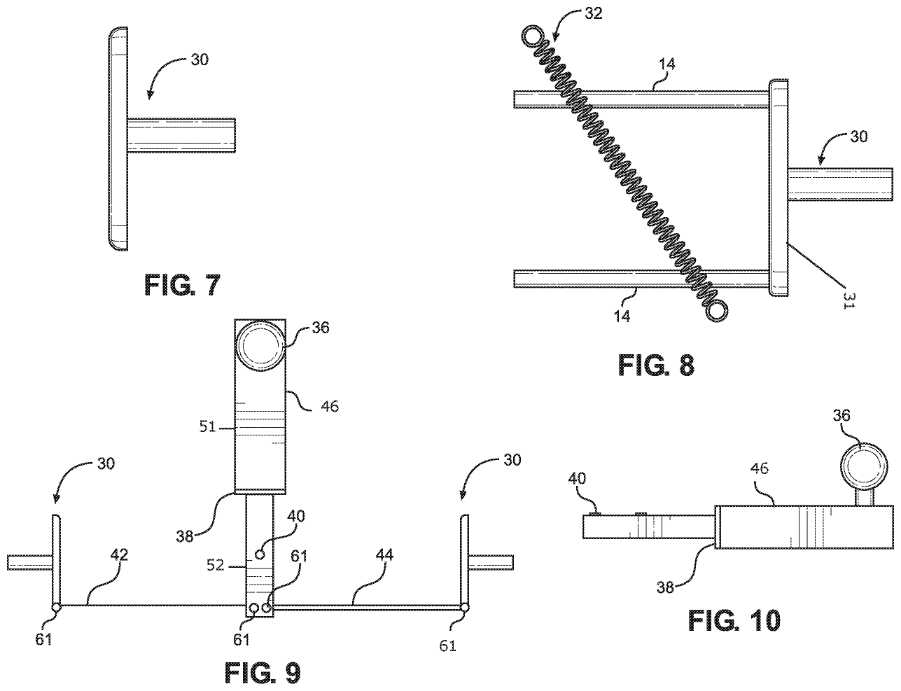

Referring to FIGS. 1 through 10, the present invention may include a towable off-road vehicle 10. The towable off-road vehicle 10 may include an outer “rollover” exterior frame 12 encompassing left-side and right-side seating with a base frame 18 extending therebetween to support said seating. Specifically, base frame 18 may provide a seat support 34 for a left-side and right-side seat 24 to support a passenger 22 in a seated position. Each seat 24 has associated lap and shoulder seat belts 26 and 28, respectively, as illustrated in FIG. 6. Each left-side and right-side portion of the exterior frame 12 a hinged door bar 20 may be provided.

The base frame 18 may also support a plurality of control arms 14 for operatively associating to an adjacent wheel 16 of a plurality of wheels 16 by way of a spindle 30 of each adjacent wheel 16—in other words, a steering system. Each wheel 16 may have two control arms 14 connecting two diametrically opposing suspension pivot points 60 (along a flange portion 31 of the associated spindle 30) to two spaced apart tie rod ends/heim joints 61 along the base frame 18, as illustrated in FIG. 3. The tie rod ends/heim joints 61 are mechanical articulating joints for operatively associating with the ends of the control arms 14. A spring/shock 32 may interconnect one of the two control arms 12 (adjacent to its suspension pivot point 60 along the flange portion 31) to the base frame 18, for providing an independent suspension system for each wheel 16.

A distal end of a left tie rod/steering rod 42 or right tie rod/steering rod 44 engages a tie rod ends/heim joints 61 also along the circumference of the flange portion 31; in certain embodiments, the tie rod ends/heim joints 61 is radially between the two diametrically opposing suspension pivot points 60 along the circumference of the same flange portion 31. The left and tie rod/steering rod steering rods 42 and 44 may extend from the opposing spindles 30 to a tie rod ends/heim joints 61 along a distal end of a proximal draw bar section 52 of a draw bar 46, respectively, as illustrated in FIG. 9.

The draw bar 46 may include an up-down pivot point 38 between a distal draw bar section 51 and the proximal draw bar section 52 of the draw bar 46. One or more lateral pivot points 40 may be provided along the proximal draw bar section 52. The distal draw bar section 51 of the draw bar 46 may provide a tow ball 36 for engaging the towing vehicle. Once assembled, the towable off-road vehicle 10 provides an intrinsic 4-wheel independent suspension system combined with an articulating tow bar 46—pivotable between an upper and lower positions (by way of the up-down pivot point 38) and pivotable between left and right positions (by way of the one or more lateral pivot point 40). As mentioned above, the towable off-road vehicle 10 provides the exterior frame 12 that securely and safety supports and its occupants 22 with roll over protection when being towed off road.

It should be understood, of course, that the foregoing relates to exemplary embodiments of the invention and that modifications may be made without departing from the spirit and scope of the invention as set forth in the following claims.

What is claimed is:

1. An off-road vehicle comprising:
a multi-wheel independent suspension system; and
an articulating tow bar.

2. The off-road vehicle of claim 1, further comprising:
a base frame;
a spindle for each wheel of the multi-wheel independent suspension system;
two control arms operatively associating each spindle to the base frame by way of tie rod ends joints; and
a spring shock operatively associating one of each two control arms to the base frame.

3. The off-road vehicle of claim 2, further comprising:
the articulating tow bar comprising:
a distal draw bar section;
a proximal draw bar section;
an up-and-down pivot point interconnecting the distal draw bar section and the proximal draw bar section;
the distal and proximal draw bar sections upwardly and downwardly movable relative to each other about the up-and-down pivot point; and
one or more lateral pivot points one the proximal draw bar section for moving laterally relative the distal draw bar section.

4. The off-road vehicle of claim 3, further comprising:
a left tie rod steering rod and a right tie rod steering rod; and
each tie rod steering rod extending from the proximal draw bar section to a tie rod ends joints on each spindle.

5. The off-road vehicle of claim 4, wherein each spindle provides a circular flange, wherein the two tie rod end articulating joints are diametrically opposed along a circumference of said circular flange, and wherein the tie rod ends joints is along the circumference between the two tie rod end articulating joints.
